(19) United States
(12) Patent Application Publication
(10) Pub. No.: US 2014/0351916 A1
(43) Pub. Date: Nov. 27, 2014

(54) ELECTRONIC DEVICE AND MONITORING METHOD

(71) Applicant: HON HAI PRECISION INDUSTRY CO., LTD., New Taipei (TW)

(72) Inventors: TSE-CHENG CHEN, New Taipei (TW); KUAN-CHIAO PENG, New Taipei (TW); CHUNG-I LEE, New Taipei (TW)

(73) Assignee: HON HAI PRECISION INDUSTRY CO., LTD., New Taipei (TW)

(21) Appl. No.: 14/287,377

(22) Filed: May 27, 2014

(30) Foreign Application Priority Data
May 27, 2013 (TW) 102118560

(51) Int. Cl. H04L 29/06

(52) U.S. Cl. CPC H04L 63/0823; H04L 63/306
USPC 726/10

(57) ABSTRACT

An electronic device establishes a communication connection with a server. The electronic device determines if the electronic device comprises other communication connections. The electronic device notifies the server to terminate the communication connection with the electronic device when the electronic device comprises other communication connections.

### FIELD

Embodiments of the present disclosure relate to monitoring technology, and particularly to an electronic device and a monitoring method.

### BACKGROUND

With the development of the mobile devices (e.g., laptops, tablets, and smart phones), employees can be permitted to remotely access privileged company information and applications using the mobile devices. For example, a department leader of a company can need to remotely access a mail system of the company to check mail using a smart phone. It is desirable to ensure information security when employees remotely access the privileged company information and applications.

### BRIEF DESCRIPTION OF THE DRAWINGS

FIG. 1 is one embodiment of an electronic device connected to a server.

FIG. 2 is a block diagram of one embodiment of a monitoring system in the electronic device in FIG. 1.

FIG. 3 is a flowchart illustrating one embodiment of a monitoring method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable storage medium or other storage device. Some non-limiting examples of non-transitory computer-readable media include CDs, DVDs, BLU-RAY, flash memory, and hard disk drives.

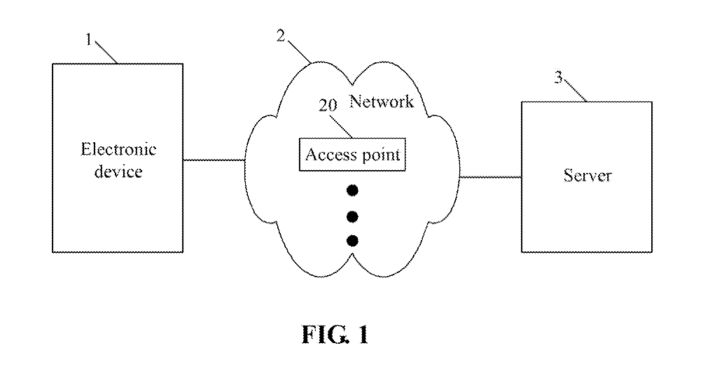

FIG. 1 is a block diagram of one embodiment of an electronic device connected to a server. Depending on the embodiment, the electronic device 1 is wirelessly connected to the server 3 via a network 2 (e.g., the Internet or a local area network), as shown in FIG. 1. The electronic device 1 can be, but is not limited to, a personal computer (PC), a tablet computer, a smart mobile phone, a portable device, or any other device. The electronic device 1 includes two or more interfaces, for example, a BLUETOOTH interface, a WIFI interface, a universal serial bus (USB) interface, or any other interface that can transmit data.

The network 2 includes one or more access points 20. The electronic device 1 accesses the network 2 by connecting to the access point 20. The access point 20 allows the electronic device 1 to connect to the network 2 using a WIFI connection. The access point 20 can be a router which provides a wireless local area network (WLAN) function, such as the WIFI connection.

The server 3 provides an authentication mechanism when the electronic device 1 accesses the server 3. In one embodiment, the server 3 provides authentication, authorization, and accounting (AAA) management when the electronic device 1 accesses the server 3. The server 3 can be, but is not limited to, a remote authentication dial in user service (RADIUS) server.

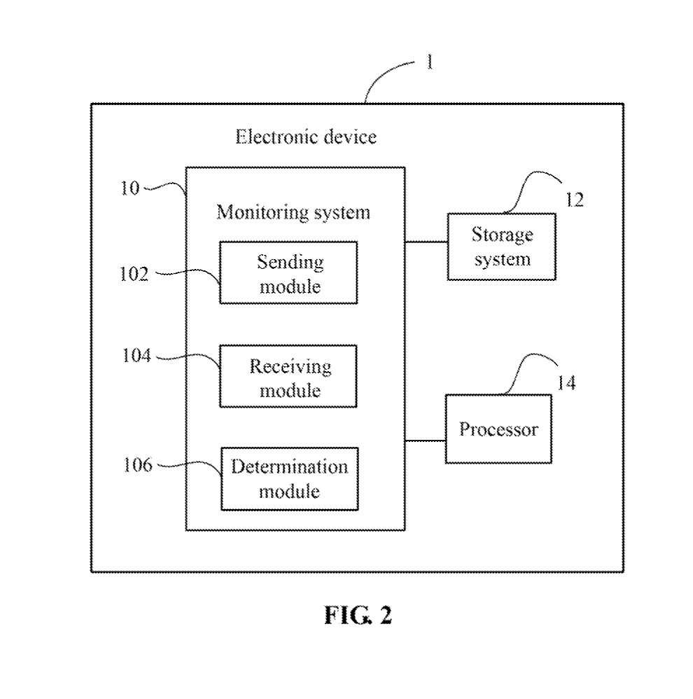

FIG. 2 is a block diagram of one embodiment of a monitoring system 10 in an electronic device 1. In one embodiment, the monitoring system 10 includes a sending module 102, a receiving module 104, and a determination module 106. The modules 102-106 can include computerized code in the form of one or more programs that are stored in a storage system 12 of the electronic device 1. The computerized code includes instructions that are executed by the at least one processor 14 of the electronic device 1 to provide functions for modules 102-106. The storage system 12 can be an internal storage system, such as a flash memory, a random access memory (RAM) for temporary storage of information, and/or a read-only memory (ROM) for permanent storage of information. The storage system 12 can also be an external storage system, such as an external hard disk, a storage card, or a data storage medium.

The sending module 102 sends a connection request to the server 3 via an access point 20 of the network 2. In one embodiment, the sending module 102 searches the access point 20 and connects to the network 2 using the searched access point 20, and sends the connection request to the server 3 using the access point 20. The connection request includes an Internet protocol (IP) address of the server 3, a login account, and a name of the electronic device 1.

The server 3 receives the connection request and authenticates if the connection request is qualified. In one embodiment, if the login account and the name of the electronic device 1 in the connection request are included in the server 3, the connection request is determined to be qualified, and the server 3 allows the electronic device 1 to access. If the login account and the name of the electronic device in the connection request are not included in the server 3, the connection request is determined to be unqualified, and the server 3 rejects access to the electronic device 1. The server 3 generates a connection certificate corresponding to the electronic device 1. The connection certificate is sent to the access point 20 which is connected to the electronic device 1, and the electronic device 1 receives the connection certificate from the access point and establishes a communication connection with the server 3. The server 3 authenticates if the connection certificate is expired when the electronic device 1 exchanges data with the server 3. The electronic device 1 can obtain data from the server 3 when the connection certificate is not expired. The electronic device 1 is rejected to obtain data from the server 3 when the connection certificate is expired, and the communication connection between the electronic device 1 and the server 3 is terminated.

The receiving module 104 receives the connection certificate from the access point 20 and establishes the communication connection with the server 3. The communication connection is established through one interface of the electronic device 1.

The determination module 106 determines if the electronic device 1 includes other communication connections. In one embodiment, the electronic device 1 includes other communication connections upon the condition that two or more interfaces are activated for transmitting data. For example, the electronic device 1 includes three interfaces, one interface is activated for establishing the communication connection with server 3, the electronic device 1 includes other communication connections when other two interfaces are activated. That is, the electronic device 1 establishes other communication connections with other devices besides the server 3.

The sending module 102 notifies the server 3 to terminate the communication connection with the electronic device 1 via the access point 20 of the network 2 when the electronic device 1 includes other communication connections. In one embodiment, the sending module 102 sends a command to the server 3 via the access point 20 and requests the server 3 to terminate the communication connection.

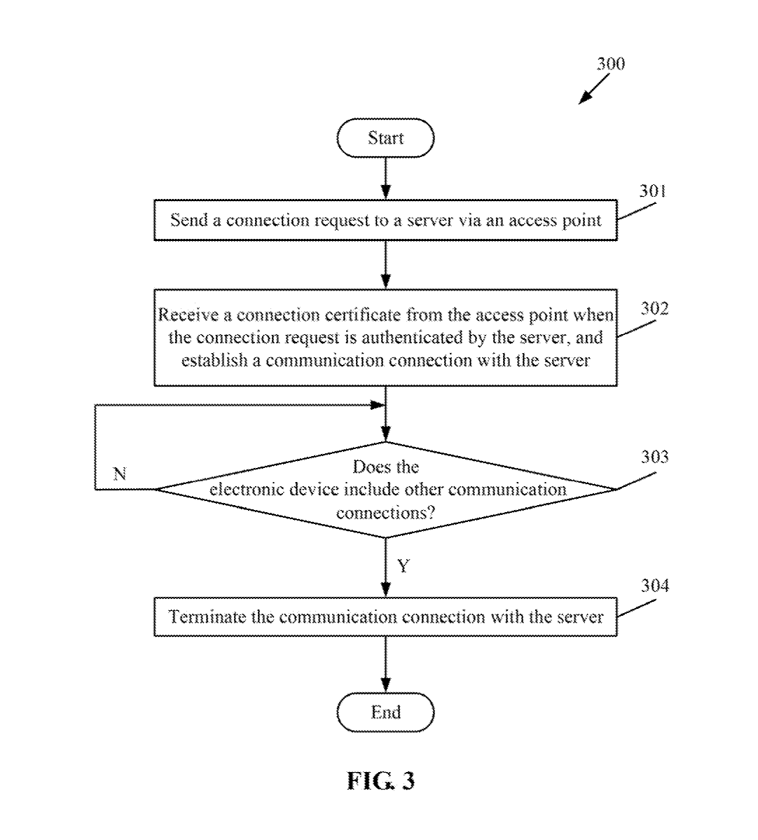

FIG. 3 is a flowchart illustrating one embodiment of a USB redirection method. In the embodiment, the method is performed by execution of computer-readable software program codes or instructions by at least one processor of a computing device.

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 301.

At block 301, a sending module sends a connection request to the server via an access point of the network. In one embodiment, the sending module sends the connection request to the server using the access point which is connected to the electronic device.

In block 302, a receiving module receives the connection certificate from the access point and establishes the communication connection with the server. The communication connection is established through WIFI interface. That is, the electronic device exchanges data with the server via the WIFI interface.

At block 303, a determination module determines if the electronic device includes other communication connections. If the electronic device 1 includes other communication connections, the procedure goes to block 304. Otherwise, if the electronic device does not include other communication connections, the procedure repeatedly executes block 303.

At block 304, a sending module notifies the server to terminate the communication connection via the access point of the network when the electronic device includes other communication connections. In one embodiment, a command is sent to the server via the access point, so as to request the server to terminate the communication connection. In addition, the server revokes the connection certificate assigned to the electronic device, so that the electronic device cannot exchange data with the server.

Although certain inventive embodiments of the present disclosure have been specifically described, the present disclosure is not to be construed as being limited thereto. Various changes or modifications can be made to the present disclosure without departing from the scope and spirit of the present disclosure.

What is claimed is:

1. An electronic device in communication with a server, the electronic device comprising:
at least one processor; and
a storage system that stores one or more programs, which when executed by the at least one processor, cause the at least one processor to:
send a connection request to the server, and the server authenticating the connection request and generating a connection certificate when the connection request is authenticated to be qualified;
receive the connection certificate from the server and establish a communication connection with the server;
determine if the electronic device comprises other communication connections; and
notify the server to terminate the communication connection with the electronic device when the electronic device comprises other communication connections.

2. The electronic device of claim 1, wherein the connection request comprises an Internet protocol (IP) address of the server, a login account, and a name of the electronic device.

3. The electronic device of claim 2, wherein the connection request is determined to be qualified if the login account and the name of the electronic device in the connection request is included in the server.

4. The electronic device of claim 1, wherein the server authenticates if the connection certificate is expired when the electronic device exchanges data with the server.

5. The electronic device of claim 1, wherein the electronic device comprises other communication connections upon the condition that two or more interfaces of the electronic device are activated for transmitting data.

6. A monitoring method between an electronic device and a server, the monitoring method comprising:
sending a connection request to the server, and the server authenticating the connection request and generating a connection certificate when the connection request is authenticated to be qualified;
receiving the connection certificate from the server and establishing a communication connection with the server;
determining if the electronic device comprises other communication connections; and
notifying the server to terminate the communication connection with the electronic device when the electronic device comprises other communication connections.

7. The monitoring method of claim 6, wherein the connection request comprises an IP address of the server, a login account, and a name of the electronic device.

8. The monitoring method of claim 7, wherein the connection request is determined to be qualified if the login account and the name of the electronic device in the connection request is included in the server.

9. The monitoring method of claim 6, wherein the server authenticates if the connection certificate is expired when the electronic device 1 exchanges data with the server.

10. The monitoring method of claim 6, wherein the electronic device comprises other communication connections upon the condition that two or more interfaces of the electronic device are activated for transmitting data.

11. A non-transitory computer-readable medium having stored thereon instructions that, when executed by an electronic device in communication with a server, causing the electronic device to perform a monitoring method, the method comprising:
sending a connection request to the server, and the server authenticating the connection request and generating a connection certificate when the connection request is authenticated to be qualified;
receiving the connection certificate from the server and establishing a communication connection with the server;
determining if the electronic device comprises other communication connections; and
notifying the server to terminate the communication connection with the electronic device when the electronic device comprises other communication connections.

12. The non-transitory computer-readable medium of claim 11, wherein the connection request comprises an IP address of the server, a login account, and a name of the electronic device.

13. The non-transitory computer-readable medium of claim 12, wherein the connection request is determined to be qualified if the login account and the name of the electronic device in the connection request is included in the server.

14. The non-transitory computer-readable medium of claim 11, wherein the server authenticates if the connection certificate is expired when the electronic device exchanges data with the server.

15. The non-transitory computer-readable medium of claim 11, wherein the electronic device comprises other communication connections upon the condition that two or more interfaces of the electronic device are activated for transmitting data.
